(19) United States
(12) Patent Application Publication
(10) Pub. No.: US 2007/0205531 A1
(43) Pub. Date: Sep. 6, 2007

(54) MULTI-LAYERED PLASTIC SLEEVE FOR A BLANKET CYLINDER AND A METHOD FOR PRODUCING THE MULTI-LAYERED PLASTIC SLEEVE

(75) Inventors: Steven O. Cormier, Green Bay, WI (US); Arun Chowdry, Pittsford, NY (US)

Correspondence Address: Andrew J. Anderson;Patent Legal Staff, Eastman Kodak Company, 343 State Street, Rochester, NY, 14650-2201, US

(73) Assignee: Eastman Kodak Company

(21) Appl. No.: 11/746,435

(22) Filed: May 9, 2007

Related U.S. Application Data
(62) Division of application No. 11/015,907, filed on Dec. 17, 2004.
(60) Provisional application No. 60/532,189, filed on Dec. 23, 2003.

(51) Int. Cl. B29C 67/00

(52) U.S. Cl. 264/238

(57) ABSTRACT

This invention relates to a multi-layered plastic sleeve and a method for producing the multi-layered plastic sleeve for use with a blanket cylinder in an electrophotographic process.

### CROSS-REFERENCE TO RELATED APPLICATIONS

This is a divisional of application Ser. No. 11/015,907 filed Dec. 17, 2004.

### FIELD OF THE INVENTION

This invention relates to a multi-layered plastic sleeve for use with a blanket cylinder in an electrophotographic process wherein the multi-layered plastic sleeve requires no metal core.

### BACKGROUND OF THE INVENTION

In electrophotographic processes requiring an image cylinder and a blanket cylinder to produce electrophotographic copies, the image cylinder typically receives a uniform charge, exposure to write an image-wise charge pattern, and a toner coating on the image area, and then transfers the toner image to a blanket cylinder. The blanket cylinder transfers the toner image to a substrate, such as paper or the like, which passes via a web between the blanket cylinder and a back pressure roller to transfer the toner image to the substrate with the substrate thereafter being fused, as well known to the art.

In such processes, the image cylinder includes a cylinder that typically has a mandrel, which may be of aluminum, steel or any other suitably durable metal or conductive plastic of a suitable thickness to produce a noncompliant member that may be about 10 millimeters (mm) in thickness. The mandrel may include reinforcing structure internally and includes a very smooth low out-of-round tolerance exterior. The image cylinder includes a mandrel and a sleeve positioned over the outside of the mandrel and is used for production and transfer of the images to the blanket cylinder. The image cylinder has a photosensitive layer on the exterior of the sleeve. The mandrel also includes bearings connected to each of its ends for positioning it in an electrophotographic copying machine and has an air inlet into an interior of the mandrel for an air discharge through a plurality of holes placed around one end of the mandrel near a tapered end of the mandrel.

The blanket cylinder includes a cylinder that typically has a mandrel, which may be of aluminum, steel or any other suitably durable metal or conductive plastic of a suitable thickness to produce a noncompliant member that may be about 10 millimeters (mm) in thickness. The mandrel may include reinforcing structure internally and includes a very smooth, low out-of-round tolerance exterior. The blanket cylinder includes a mandrel and a sleeve positioned over the outside of the mandrel and is used for transfer of the images from the blanket cylinder to a substrate. The mandrel also includes bearings connected to each of its ends for positioning it in an electrophotographic copying machine and has an air inlet into an interior of the mandrel for an air discharge through a plurality of holes placed around one end of the mandrel near a tapered end of the mandrel.

The sleeves have been produced by use of a metal core, which is typically a noncompliant metal member, such as nickel or the like, which is produced by plating. The core must be seamless and must provide a very low variation surface outer diameter. The plastic layer is then positioned around the outside of the metal core, the metal core is mounted on a mandrel or the like, and the plastic layer is machined to a desired thickness. Additional exterior coatings have been applied by techniques such as ring coating and the like. The completed sleeve will have an internal diameter slightly less than the outer diameter of the mandrel upon which it is to be placed. This interference fit allows the sleeve to be firmly positioned on the outside of the mandrel after it is installed. The sleeve must have a smooth exterior and a closely controlled wall thickness.

The sleeve is typically installed by urging it toward and onto the tapered end section of the mandrel while air is ejected through the holes at the end of the mandrel near the tapered section. The air injection permits the positioning of the sleeve on the mandrel by an air bearing technique as known to those skilled in the art. The interference fit between the sleeve and the mandrel is accomplished and the sleeve is retained snugly and firmly in position on the outside of the mandrel. The outside of the mandrel, including the sleeve, must have an outside diameter variation within a range of about +/−12.5 microns. This close tolerance is necessary to ensure accurate receipt of images from the image cylinder and transmission of the images to the substrate by the blanket cylinder.

There are various other specific requirements for the blanket cylinder and it has been previously considered necessary to meet these other requirements as well as those discussed above by the use of a metal core in the sleeve. This is a relatively expensive, time-consuming step and the cores are relatively expensive. As a result, a continued effort has been directed to producing sleeves more economically that will meet the demanding requirements for the blanket cylinder sleeves.

### SUMMARY OF THE INVENTION

According to the present invention, plastic sleeves that do not include a metal core are produced for use with a blanket cylinder. Such sleeves provided by producing a multi-layered plastic sleeve for use with a blanket cylinder in an electrophotographic process, the method including positioning a quantity of an outer coating material for the blanket cylinder sleeve on the inside of a mold having an inner surface and a longitudinal axis and an inner diameter equal to the desired outer diameter of the sleeve, the quantity being an amount sufficient to produce a selected thickness on the inside of the mold and distributed uniformly on the inner surface of the mold; positioning a second quantity of at least one of a liquid or liquefiable plastic at a temperature below 100° C. and liquid plastic precursors of a plastic in the mold containing the outer coating material, the second quantity being an amount sufficient to produce the sleeve of a selected thickness; rotating the mold about its longitudinal axis to produce a centrifugal force of at least about 5 times the force of gravity at the inside of the mold; heating the mold to a temperature from about 25 to about 100° C. during rotation of the mold; and removing the sleeve from the mold, the sleeve having a wall thickness from about 1 to about 20 mm.

The invention also includes producing a multi-layered plastic sleeve having a sleeve wall thickness for use with a blanket cylinder in an electrophotographic process, the method including positioning a quantity of an outer coating material for the blanket cylinder sleeve, a quantity of plastic material consisting of at least one of a liquid or liquefiable plastic at a temperature below 100° C. and liquid plastic precursors in a mold having an inside, an inner diameter equal to the desired outer diameter of the sleeve, an inner surface and a longitudinal axis, the quantity of each of the outer coating material and of each of the plastic materials being an amount sufficient to produce a layer of each of the materials in the sleeve wall of a selected thickness, the materials having different specific gravities so that the outer coating material is formed as an outside of the sleeve; rotating the mold about its longitudinal axis to produce a centrifugal force of at least about 5 times the force of gravity at the inside of the mold; heating the mold to a temperature from about 25 to about 100° C. during rotation of the mold; and removing the sleeve from the mold, the sleeve having a wall thickness from about 1 to about 20 mm.

The invention further provides for producing a multi-layered plastic sleeve having a sleeve wall thickness for use with a blanket cylinder in an electrophotographic process, the method including positioning a plurality of plastic materials consisting of liquid or liquefiable plastic at a temperature below 100° C. and liquid plastic precursors in a mold having an inside, an inner diameter equal to the desired outer diameter of the sleeve, an inner surface and a longitudinal axis, the quantity of each of the plastic materials being an amount sufficient to produce a layer of each of the plastic materials in the sleeve wall of a selected thickness, the plastic materials having different specific gravities so that layers of the plastic materials are formed in the sleeve wall; rotating the mold about its longitudinal axis to produce a centrifugal force of at least about 5 times the force of gravity at the inside of the mold; heating the mold to a temperature from about 25 to about 100° C. during rotation of the mold; and removing the sleeve from the mold, the sleeve having a wall thickness from about 1 to about 20 mm.

The invention further provides a sleeve for a blanket cylinder in an electrophotographic process, the cylinder including an outer layer selected from a ceramer and fluorocarbon polymers and copolymers; and, at least two inner layers inside the outer layer, the each inner layers consisting of different plastic materials selected from a liquid or liquefiable plastic at a temperature below 100° C. and a rigid polyurethane, the sleeve having a wall thickness from about 1 to about 20 mm with a wall thickness variation of about +/−12.5 mm from an average wall thickness.

### BRIEF DESCRIPTION OF THE DRAWINGS

FIG. 1 shows an embodiment of a process and system wherein a blanket cylinder according to present invention is used;

FIG. 2 is a schematic diagram of a mandrel and a sleeve, with the sleeve being positioned for installation on the mandrel;

FIG. 3 is a schematic diagram of a sleeve positioned on the mandrel;

FIG. 4 is a schematic diagram of a mold positioned for rotation and injection of plastic material to form a plastic sleeve according to the present invention;

FIG. 5 shows a mold with its ends removed that has been coated with an outer coating material for the sleeve; and

FIG. 6 shows a mold containing a multi-layered sleeve.

### DESCRIPTION OF PREFERRED EMBODIMENTS

In the description of the figures, the same numbers will be used to refer to the same or similar components throughout in the discussion of the figures.

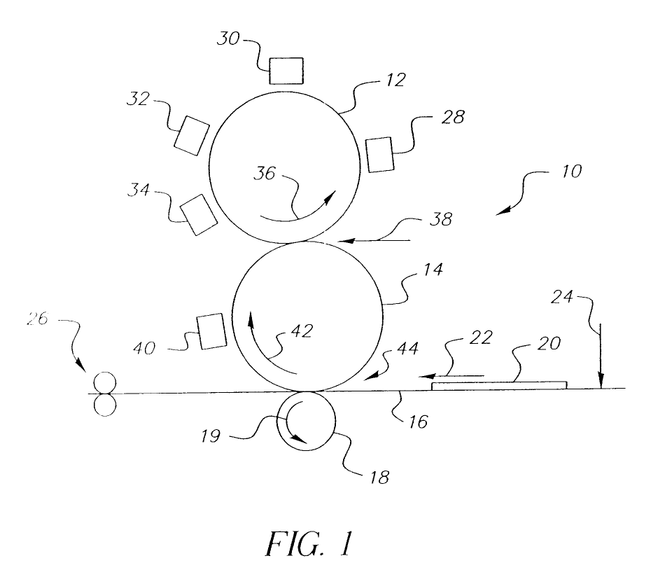

In FIG. 1, an electrophotographic process and system 10 are shown. The process includes a blanket cylinder 12 positioned in engagement with a blanket cylinder 14, which is positioned in engagement with a web 16 and a back pressure roller 18. A substrate 20, which may be paper or the like, is passed along web 16 between blanket cylinder 14 and back pressure roller 18. The substrate, now bearing an image, is passed along web 16 to a fuser section 26 where it is fused as known to those skilled in the art. The direction of travel of the substrate is shown by arrow 22. A sensor 24 is positioned to ensure that substrate 20 passes in contact with blanket cylinder 14 at a proper time so that the image is properly positioned on substrate 20.

In the operation of the process, image cylinder 12 rotates in a direction shown by arrow 36 and blanket cylinder 14 rotates in a direction shown by arrow 42. Back pressure roller 18 turns in a direction as shown by arrow 19. A nip 38 is formed between image cylinder 12 and blanket cylinder 14. The nip is typically about 4.5+/−1 mm in width. Similarly, a nip 44 is formed between blanket cylinder 14 and back pressure roller 18. This nip is about 4 to about 10 mm in width.

A cleaning station 28 is positioned to contact the surface of image cylinder 12 after it passes nip 38. The clean cylinder surface then passes a charger station 30, a writer station 32 where an electrostatic image is placed on the surface of cylinder 12 and a toner section 34 that applies toner to the electrostatic image, which is then transferred at nip 38 to blanket cylinder 14. Blanket cylinder 14 transfers the image to substrate 20 and is thereafter cleaned by a cleaner 40 to ensure that a clean surface is provided on blanket cylinder 14 for transfer of an additional image from image cylinder 12.

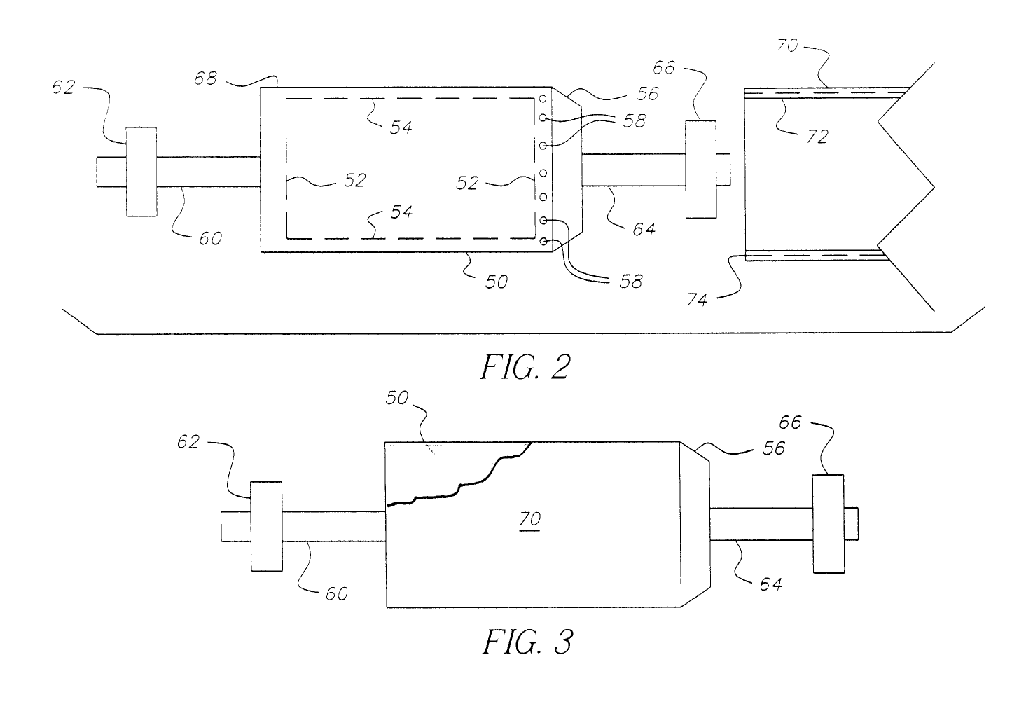

Image cylinder 12 and blanket cylinder 14 are both of similar construction, although the materials and properties of their exteriors are different. As shown in FIG. 2, blanket cylinder 12 includes a mandrel 50 that has side walls 54 and ends 52, and has a tube 60 which supports a bearing 62 in operative engagement with one end of mandrel 50 and a shaft 64 which supports a second bearing 66 in operative engagement with the other end of mandrel 50.

Tube 60 is adapted for the injection of air into mandrel 50, which includes near one of its ends, a taper 56, and a plurality of air holes 58. These air holes are used for the ejection of air during the installation of a sleeve over mandrel 50. Mandrel 50 has an outside diameter 68, which is somewhat larger than the inner diameter 72 of a sleeve 70. Sleeve 70 as shown, is a plastic sleeve according to the present invention. Its end 74 is urged into engagement with tapered section 56 of mandrel 50 and the sleeve is placed over an outside diameter 68 of mandrel 50 by an air step process using the ejection of air through holes 58.

In FIG. 3, an installed sleeve, according to the present invention, is shown on mandrel 50. The mandrel and sleeve that provide blanket cylinder 14 are now assembled.

The blanket cylinder may have a diameter from about 2 cm to about 400 cm. While the mandrel diameter may vary widely, the variations in diameter or the out of round run out must be limited to +/−12.5 microns. This is necessary to ensure that the proper nip is achieved with the blanket cylinder and the image cylinder and that good image transfer from the image cylinder to the blanket cylinder and from the blanket cylinder to the substrate is accomplished.

Desirably the outside of blanket cylinder sleeve 70 has a Shore A hardness of about 60+/−5. The hardness is readily varied by changing the formulation of the plastic, as well known to those skilled in the art. The thickness of the sleeve wall may be from about 1 to about 20 mm. The sleeve wall is plastic and is rigid enough to handle. Further the plastic desirably has a conductivity of at least 10⁸ to 10¹⁴ ohms·cm. Generally the conductivity of the blanket cylinder sleeve is less than for the image cylinder sleeve, although the charge on the blanket cylinder is typically higher than that on the image cylinder. To produce an acceptable exterior surface on blanket cylinder 14, it is necessary that the wall thickness of the sleeve be held to a thickness variation of +/−12.5 microns. Generally the blanket cylinder sleeve exterior is more compliant than the exterior of the image cylinder sleeve.

Sleeves have been formed in the past by positioning the sleeves on a seamless metal core, which is typically a nickel core formed by plating. The metal core provided support for the positioning of the plastic around the metal core and then the plastic was machined to the required size. Both the requirement for the metal core and the requirement for machining represent expensive and time consuming operations that have been required to achieve the precision necessary to produce the sleeves for the blanket cylinder.

As well known to those skilled in the art, a thin hard release layer such as a sol-gel, a ceramer or a fluorocarbon polymer or copolymer may be placed on the outside of the sleeve for the blanket cylinder. This layer has been applied by processes such as ring coating, dipping and the like. It is also known that inorganic or organic layers may be applied over the outside of the sleeve to modify surface properties such as surface energy. The use and application of such outer layers by such techniques is not considered to constitute part of the present invention, which is directed to the production of a sleeve for a blanket cylinder meeting the exacting requirements for such a sleeve.

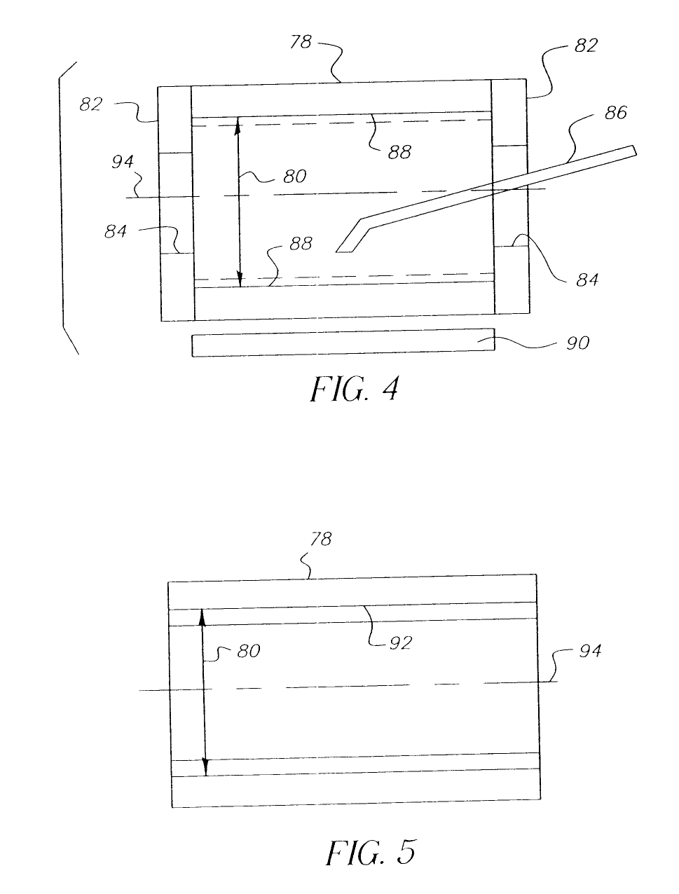

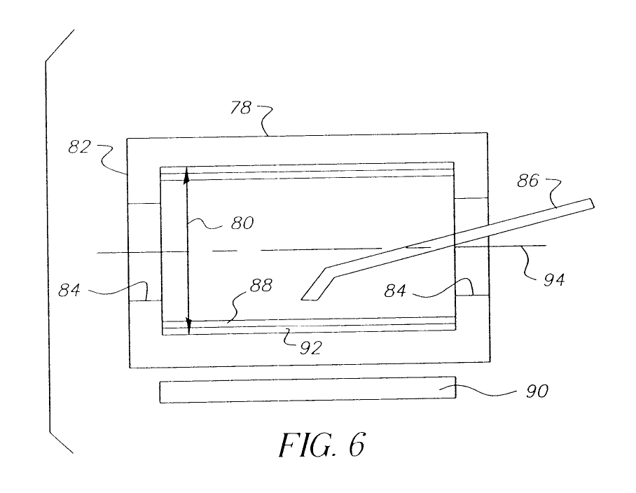

In FIG. 4, a suitable mold is shown. The mold has a mold wall 78 having an inner diameter 80 with ends 82 positioned to form a mold surface inside the mold with the liquid materials in the mold being restrained by ends 82. Plastics, plastic precursors, and the like may be injected through a pipe 86 to form a layer 88 or a plurality of layers as disclosed in FIG. 6.

Mold 78 includes a longitudinal axis 94 and a heater 90, which is positioned to heat the mold. In operation, the plastic materials are placed in the mold and the mold is then rotated to produce a centrifugal force equal to at least five times the force of gravity at the inside of mold 78, and desirably from about 5 to about 100 times the force of gravity. The centrifugal force is produced by rotating the mold 78 about its longitudinal axis 94.

While in FIG. 4, the formation of a single layer is shown, the present invention relates to the formation of multiple layers, as shown in FIG. 6. While two layers are shown, it should be understood that more layers may be formed. The layers, as formed, are produced by adding materials having different specific gravities to the mold and thereafter heating and rotating the mold. Substantially any plastic material is suitable so long as it is or becomes liquid at temperatures below about 100° C. and solidifies upon cooling. Both thermosetting and thermoplastic materials may be used and outer coating materials may be used as well, provided that they become solid materials at the temperatures to which the mold is ultimately cooled, i.e., typically 25° C.

The uniformity of the sleeve wall is achieved by the distribution of the liquid materials over the inner surface of the mold as a result of centrifugal force. The rotation is continued until the materials have been cooled. Thereafter the sleeve is readily removed from the inside of the mold since it typically contracts slightly when cooled.

According to the present invention, such sleeves are readily produced using plastic precursors, suitable liquid plastics, or liquefiable plastics in a mold with the mold then being heated by a heater 90 to a suitable temperature to result in the presence of the plastic in the mold in a liquid form. A suitable mold is shown schematically in FIG. 4.

The mold includes a mold having a wall 78 and ends 82. Openings 84 are generally left in the ends. While the plastic could be introduced in a number of ways, it is shown as being introduced through a tube 86 that supplies a quantity of plastic suitable to form a sleeve of the desired thickness and of uniform thickness in the mold. The uniformity is achieved by spinning the mold while the plastic is heated and as the plastic moves through a molten phase. The molding may be done with a thermoplastic material, which after liquefying is allowed to cool back into a hardened phase. The formation of the solid sleeve is accomplished with rotation of the mold at a rate sufficient to produce a centrifugal force equal to at least five and preferably at least about 10 and desirably from about 5 to about 10 times the force of gravity at the inside of the mold until the plastic has solidified.

According to the present invention, such sleeves are readily produced by a method wherein, a plurality of materials having different specific gravities are positioned in a mold having an inner surface and a longitudinal axis with the materials being placed in the mold in a quantity sufficient to produce a layer of each of the materials in the sleeve wall of a selected thickness. The materials have different specific gravities so that as the mold is rotated to produce a centrifugal force of desirably from 5 to 100 times the force of gravity at the inside of the mold, the layers form from the materials as they become molten. Typically, plastic materials and other materials that are liquid or liquefiable at temperatures up to 100° C. are used to form the sleeve wall. Finely divided particulate solid materials could be used as one component if desired. Useful plastics are preferably rigid polyurethane resins that are produced in the mold 30 from liquid plastic precursor materials. Thermosetting and thermoplastic polymers may also be used provided they become suitably liquid at the temperatures in the mold and that they become suitably solid at the temperatures at which the sleeves are removed from the mold, which is typically at temperatures of about 25° C.

In some instances, the materials added to the mold are plastic materials, which may be liquid or solid as added, although if solid plastic materials are added to the mold they must be liquefiable at a temperature below 100° C. Plastic precursors are used to form the rigid polyurethane plastics. Similarly outer coating materials such as ceramers, fluorocarbon polymers and copolymers and the like may be added as well. When the materials added are of suitable density, they form layers with the ceramer or fluorocarbon polymer or copolymer desirably being formed as the inner layer in the mold, i.e., the outer layer of the sleeve as formed. The other plastics may be selected to form layers as desired. A wide variety of plastics are useful in the present invention.

In one embodiment, as shown in FIG. 5, a ceramer, fluorocarbon polymer or copolymer or the like desired as an outer coating material on the sleeve can be ring coated or otherwise positioned on the inside of a mold 78. Conveniently this is accomplished by removing ends 82 from the mold as shown in FIG. 4 so that the outer coating material may be readily applied by ring coating, dipping or the like. The mold is then closed and the other plastics may be added as desired to form additional layers. A single layer may be formed, thereby constituting a multi-layer sleeve with the plastic taken in conjunction with the outer coating material or a plurality of plastic layers may be used.

Alternatively the outer coating materials and the plastics to form the other layers may be mixed and added to the mold as shown in FIG. 4. In still a further alternative, a layered sleeve may be formed as shown in FIG. 4 by injecting a mixture of plastic materials which by rotation heating of mold 70 form a multi-layered sleeve that may then be removed and may be coated on its exterior by an outer coating material, such as ceramer, fluorocarbon polymers or copolymers and the like.

Suitable plastics include thermoplastic, thermosetting and elastomeric plastics and particularly polyurethanes are preferred. With polyurethanes, polymer precursors may be placed into the mold and allowed to polymerize, cross-link and otherwise react to form the desired plastics as the mold spins. Polysiloxanes may also be used. In any event, it has been found that when the inside of the mold is formed to have a surface within the required variations for the outside of the sleeve, that the inside of the sleeve and the sleeve wall thickness can be produced to sufficiently close tolerances by this method to enable its positioning over a mandrel and use on the blanket cylinder.

The heating and cooling of the mold may be at rates deemed suitable for the particular plastic used and desirably the rotation of the mold is continued until the plastic has reached a temperature of about 100° C. and thereafter until the plastic is cooled to a temperature selected for convenience in handling and the like. After cooling the sleeve typically releases from the inside of the mold by contraction of the plastic so that the sleeve is readily removed from the mold by simply removing one of ends 82 and removing the sleeve. The sleeve is then ready for use or for coating with additional materials that may be desired on its exterior. A heater 90 is shown but it will be understood that any suitable type of heater can be used.

By the process of the present invention, multi-layered sleeves for the blanket cylinder can be produced much more economically and more efficiently than with previously used methods. The sleeves produced have a plastic sleeve for use by positioning it over an outer diameter of a mandrel. The plastic sleeve has a wall thickness from about 1 to about 20 mm, an inner diameter smaller than the outer diameter of the mandrel, a Shore A hardness of about 60+/−5 and a wall thickness variation of no more than about +/−12.5 microns from the average wall thickness. These sleeves are highly desirable as replacement sleeves around the outside of mandrels in blanket cylinders. These sleeves are also much more economically produced while providing sleeves of an equivalent or superior quality to sleeves produced by prior art methods.

By contrast to image cylinder sleeves, the blanket cylinder sleeves require a low surface energy exterior that will readily accept and release toner images. By contrast the image cylinder has an exterior that includes a photosensitive material. Typically the sleeves for the image cylinder include a substrate with a smoothing coat placed over the substrate, a barrier coat placed over the smoothing coat, a charge coat placed over the barrier coat and a charge transfer coat positioned over the charge coat. Positioning these coatings over the image cylinder sleeve is extremely difficult by the selection of materials having suitably different densities. Image cylinder sleeves may be produced by the present invention for subsequent addition of the surface coating materials.

Accordingly, the method of the present invention is considered to be primarily useful in conjunction with blanket cylinder sleeves. For a variety of reasons related to the desired properties in the sleeves, the blanket cylinder sleeves may desirably be of a multi-layered construction to achieve a variety of properties readily achievable by the use of multiple layers of different plastic materials.

As well known to those skilled in the art, it is desirable in some instances to modify the surface energy properties of the blanket cylinder sleeve. This may be readily accomplished by coating a suitable surface energy modifying material onto the surface of the sleeve. This may readily be done by ring coating or the like.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

What is claimed is:

1. A method for producing a multi-layered plastic sleeve for use with a blanket cylinder in an electrophotographic process, the method comprising:
a. positioning a quantity of an outer coating material for the blanket cylinder sleeve on the inside of a mold having an inner surface and a longitudinal axis and an inner diameter equal to the desired outer diameter of the sleeve, the quantity being an amount sufficient to produce a selected thickness on the inside of the mold and distributed uniformly on the inner surface of the mold;
b. positioning a second quantity of at least one of a liquid or liquefiable plastic at a temperature below 100° C. and liquid plastic precursors of a plastic in the mold containing the outer coating material, the second quantity being an amount sufficient to produce the sleeve of a selected thickness;
c. rotating the mold about its longitudinal axis to produce a centrifugal force of at least about 5 times the force of gravity at the inside of the mold;
d. heating the mold to a temperature from about 25 to about 100° C. during rotation of the mold; and
e. removing the sleeve from the mold, the sleeve having a wall thickness from about 1 to about 20 mm.

2. The method of claim 1, wherein the outer coating material is a ceramer or a fluorocarbon polymer or copolymer.

3. The method of claim 1, wherein the blanket cylinder has an outer diameter from about 2 cm to about 400 cm.

4. The method of claim 1, wherein the plastic is a rigid polyurethane plastic.

5. The method of claim 1, wherein the plastic is a thermoplastic plastic.

6. The method of claim 1, wherein the plastic is a thermosetting plastic.

7. The method of claim 1, wherein the sleeve has a wall thickness variation of no more than +/−12.5 microns from the average wall thickness.

8. The method of claim 1, wherein the centrifugal force is from about 5 to about 10 times the force of gravity.

9. The method of claim 1, wherein the outer coating is applied to the inside of the mold by ring coating.

10. The method of claim 1, wherein a plurality of plastics are positioned in the mold, the plastics having different specific gravities.

11. The method of claim 10, wherein the plurality of plastics form a plurality of layers in the sleeve wall during rotation of the mold.

12. A method for producing a multi-layered plastic sleeve having a sleeve wall thickness for use with a blanket cylinder in an electrophotographic process, the method comprising:
a. positioning a quantity of an outer coating material for the blanket cylinder sleeve, a quantity of plastic material consisting of at least one of a liquid or liquefiable plastic at a temperature below 100° C. and liquid plastic precursors in a mold having an inside, an inner surface and a longitudinal axis, the quantity of each of the outer coating material and of each of the plastic materials being an amount sufficient to produce a layer of each of the materials in the sleeve wall of a selected thickness, the materials having different specific gravities so that the outer coating material is formed as an outside of the sleeve;
b. rotating the mold about its longitudinal axis to produce a centrifugal force of at least about 5 times the force of gravity at the inside of the mold;
c. heating the mold to a temperature from about 25 to about 100° C. during rotation of the mold; and
d. removing the sleeve from the mold, the sleeve having a wall thickness from about 1 to about 20 mm.

13. The method of claim 12, wherein the outer coating material is a ceramer or a fluorocarbon polymer or copolymer.

14. The method of claim 12, wherein the plastic is a rigid polyurethane plastic.

15. The method of claim 12, wherein the sleeve has a wall thickness variation of no more than +/−12.5 microns from the average wall thickness.

16. The method of claim 12, wherein a plurality of plastics are positioned in the mold, the plastics having different specific gravities.

17. The method of claim 12, wherein the plurality of plastics form a plurality of layers in the sleeve wall during rotation of the mold.

18. A method for producing a multi-layered plastic sleeve having a sleeve wall thickness for use with an image cylinder or a blanket cylinder in an electrophotographic process, the method comprising:
a. positioning a plurality of plastic materials consisting of liquid or liquefiable plastic at a temperature below 100° C. and liquid plastic precursors in a mold having an inside, an inner surface and a longitudinal axis, the quantity of each of the plastic materials being an amount sufficient to produce a layer of each of the plastic materials in the sleeve wall of a selected thickness, the plastic materials having different specific gravities so that layers of the plastic materials are formed in the sleeve wall;
b. rotating the mold about its longitudinal axis to produce a centrifugal force of at least about 5 times the force of gravity at the inside of the mold;
c. heating the mold to a temperature from about 25 to about 100° C. during rotation of the mold; and
d. removing the sleeve from the mold, the sleeve having a wall thickness from about 1 to about 20 mm.

19. The method of claim 18, wherein one of the plastic materials include a rigid polyurethane plastic.

20. The method of claim 18, wherein one of the plastic materials include a thermoplastic plastic.

21. The method of claim 18, wherein one of the plastic materials include a thermosetting plastic.

22. The method of claim 18, wherein the sleeve has a wall thickness variation of no more than +/−12.5 microns from the average wall thickness.

23. The method of claim 18, wherein the centrifugal force is from about 5 to about 10 times the force of gravity.
